(19) United States
(12) Patent Application Publication
(10) Pub. No.: US 2025/0102971 A1
(43) Pub. Date: Mar. 27, 2025

(54) IMAGE FORMING APPARATUS

(71) Applicant: FUJIFILM Business Innovation Corp., Tokyo (JP)

(72) Inventor: Ko UMENAI, Kanagawa (JP)

(73) Assignee: FUJIFILM Business Innovation Corp., Tokyo (JP)

(21) Appl. No.: 18/444,767

(22) Filed: Feb. 19, 2024

(30) Foreign Application Priority Data
Sep. 26, 2023 (JP) 2023-163163

(51) Int. Cl. G03G 15/20; G03G 15/00

(52) U.S. Cl. CPC G03G 15/2028; G03G 15/657; G03G 2215/00679

(57) ABSTRACT

An image forming apparatus includes: a transfer cylinder that sandwiches a transported recording medium while rotating and that transfers an image onto the recording medium, the recording medium being sandwiched between the transfer cylinder and a transfer member onto which the image is transferred; a heating roll that is disposed downstream of the transfer cylinder in a transport direction of the recording medium and that heats the transported recording medium while rotating; a pressing cylinder that is disposed to face the heating roll, that rotates in synchronization with rotation of the transfer cylinder, and that presses the transported recording medium toward the heating roll; an approach and separation mechanism that includes a cam member that rotates together with the pressing cylinder and a cam follower that is connected to the heating roll and that is pressed against a cam surface of the cam member, the approach and separation mechanism causing the heating roll to approach the pressing cylinder and to be separated from the pressing cylinder; and a suppression unit that suppresses load torque that acts on the pressing cylinder since the approach and separation mechanism causes the heating roll to approach the pressing cylinder and to be separated from the pressing cylinder.

### CROSS-REFERENCE TO RELATED APPLICATIONS

This application is based on and claims priority under 35 USC 119 from Japanese Patent Application No. 2023-163163 filed Sep. 26, 2023.

### BACKGROUND

### (i) Technical Field

The present invention relates to an image forming apparatus.

### (ii) Related Art

A transfer device described in JP2010-281895A includes: a transfer roller including a roller base material that faces an image carrier body carrying an image, that rotates around a rotation axis, and that is provided with a recess portion provided at a peripheral surface of the roller base material, the transfer roller transferring the image carried by the image carrier body to a recording medium while the recess portion does not face the image carrier body; a pressing portion that presses the transfer roller against the image carrier body; and an abutment portion that is provided at a position corresponding to the recess portion in a direction along the rotation axis. The abutment portion includes a peripheral surface that abuts a support portion provided at a drive transmission portion that transmits drive to the image carrier body while the recess portion faces the image carrier body and the peripheral surface of the abutment portion is provided with an elastic member.

### SUMMARY

An image forming apparatus includes a transfer cylinder that transfers an image to a recording medium while rotating, a heating roll that is disposed downstream of the transfer cylinder in a transport direction of the recording medium and that heats the recording medium while rotating with the recording medium being transported, and a pressing cylinder that is disposed to face the heating roll and that presses the recording medium toward the heating roll while rotating with the recording medium being transported. Furthermore, the image forming apparatus includes an approach and separation mechanism that causes the heating roll to approach the pressing cylinder and to be separated from the pressing cylinder and rotation of the pressing cylinder and rotation of the transfer cylinder are synchronized with each other.

In such an image forming apparatus, the approach and separation mechanism causes the heating roll to approach the pressing cylinder and to be separated from the pressing cylinder and thus a fluctuation in load torque occurs at the pressing cylinder, which causes a fluctuation in rotation speed of the pressing cylinder. In addition, since the rotation of the pressing cylinder and the rotation of the transfer cylinder are synchronized with each other, the fluctuation in rotation speed of the pressing cylinder causes a fluctuation in rotation speed of the transfer cylinder.

Aspects of non-limiting embodiments of the present disclosure relate to an image forming apparatus that suppress a fluctuation in rotation speed occurring at a transfer cylinder in comparison with a case where a fluctuation in load torque occurring at a pressing cylinder becomes a fluctuation in rotation speed of the pressing cylinder as it is in a configuration in which rotation of the pressing cylinder and rotation of the transfer cylinder are synchronized with each other.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: a transfer cylinder that sandwiches a transported recording medium while rotating and that transfers an image onto the recording medium, the recording medium being sandwiched between the transfer cylinder and a transfer member onto which the image is transferred; a heating roll that is disposed downstream of the transfer cylinder in a transport direction of the recording medium and that heats the transported recording medium while rotating; a pressing cylinder that is disposed to face the heating roll, that rotates in synchronization with rotation of the transfer cylinder, and that presses the transported recording medium toward the heating roll; an approach and separation mechanism that includes a cam member that rotates together with the pressing cylinder and a cam follower that is connected to the heating roll and that is pressed against a cam surface of the cam member, the approach and separation mechanism causing the heating roll to approach the pressing cylinder and to be separated from the pressing cylinder; and a suppression unit that suppresses load torque that acts on the pressing cylinder since the approach and separation mechanism causes the heating roll to approach the pressing cylinder and to be separated from the pressing cylinder.

### BRIEF DESCRIPTION OF THE DRAWINGS

Exemplary embodiment(s) of the present invention will be described in detail based on the following figures, wherein:

FIG. 1 is a schematic configuration view showing an image forming apparatus according to a first exemplary embodiment of the present disclosure;

FIG. 2 is a schematic configuration view showing a toner image forming unit of the image forming apparatus according to the first exemplary embodiment of the present disclosure;

FIG. 3 is a perspective view showing a chain gripper of the image forming apparatus according to the first exemplary embodiment of the present disclosure;

FIG. 4 is a perspective view showing a secondary transfer roll or the like of a transfer device according to the first exemplary embodiment of the present disclosure;

FIG. 5 is a perspective view showing a heating roll, a pressing roll, and the like of the image forming apparatus according to the first exemplary embodiment of the present disclosure;

FIG. 6 is a cross-sectional view showing the heating roll, the pressing roll, and the like of the image forming apparatus according to the exemplary embodiment of the present disclosure;

FIG. 7 is a front view showing an approach and separation mechanism, a suppression unit, and the like of the image forming apparatus according to the first exemplary embodiment of the present disclosure;

FIGS. 8A to 8C are operation views for description of the operation of the approach and separation mechanism of the image forming apparatus according to the first exemplary embodiment of the present disclosure;

FIG. 9 is a graph showing torque applied to a pressing roll of the image forming apparatus according to the first exemplary embodiment of the present disclosure; and

FIG. 10 is a front view showing an approach and separation mechanism, a suppression unit, and the like of an image forming apparatus according to a second exemplary embodiment of the present disclosure.

### DETAILED DESCRIPTION

### First Exemplary Embodiment

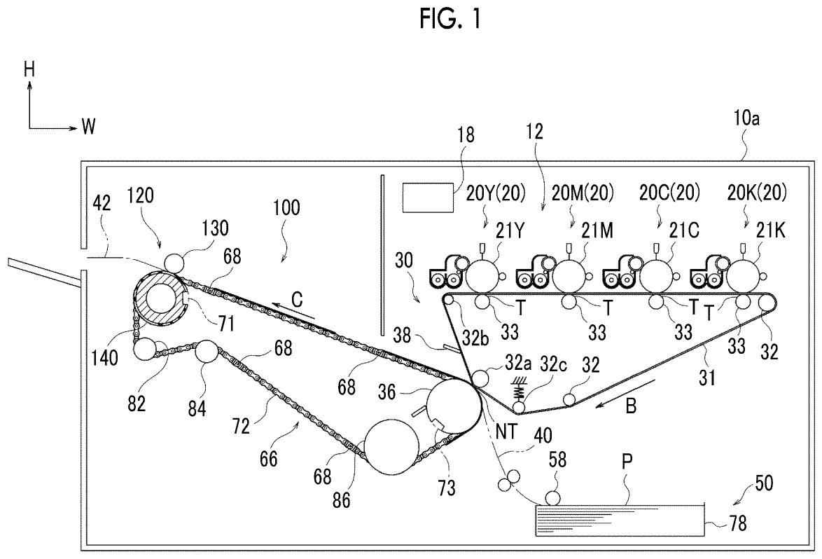

An example of an image forming apparatus according to a first exemplary embodiment of the present disclosure will be described with reference to FIGS. 1 to 9. An arrow H shown in the drawings indicates an apparatus up-and-down direction (a vertical direction), an arrow W indicates an apparatus width direction (a horizontal direction), and an arrow D indicates an apparatus depth direction (a horizontal direction).

An image forming apparatus 10 according to the present exemplary embodiment is an electrophotographic image forming apparatus that forms a toner image on a sheet member P, which is a recording medium. As shown in FIG. 1, the image forming apparatus 10 includes an accommodation unit 50, an image forming unit 12, and a control unit 18 that controls each unit.

### Accommodation Unit 50

The accommodation unit 50 has a function of accommodating the sheet member P. As shown in FIG. 1, the accommodation unit 50 includes a loading portion 78 onto which the sheet member P is loaded and a feeding roll 58 that feeds, to a supply path 40, the uppermost sheet member P loaded on the loading portion 78.

### Image Forming Unit 12

The image forming unit 12 has a function of forming an image on the sheet member P by means of an electrophotographic method. As shown in FIG. 1, the image forming unit 12 is disposed above the accommodation unit 50. More specifically, the image forming unit 12 includes toner image forming units 20 that form toner images, a transfer device 30 that transfers the toner images formed by the toner image forming units 20 to the sheet member P, and a fixing device 100 that fixes the toner images onto the sheet member P.

### Toner Image Forming Unit 20

A plurality of the toner image forming units 20 are provided to form toner images of respective colors. In the image forming unit 12, the toner image forming units 20 for a total of four colors which are yellow (Y), magenta (M), cyan (C), and black (K) are provided. (Y), (M), (C), and (K) shown in FIG. 1 indicate constituent parts corresponding to the respective colors.

Basically, a toner image forming unit 20Y, a toner image forming unit 20M, a toner image forming unit 20C, and a toner image forming unit 20K have the same configuration as each other except for a toner to be used.

As shown in FIG. 1, the toner image forming units 20Y, 20M, 20C, and 20K are arranged along a horizontal portion of a transfer belt 31 of the transfer device 30. In the following description, the toner image forming units 20Y, 20M, 20C, and 20K will be described without alphabets letters at the ends in a case where the toner image forming units 20Y, 20M, 20C, and 20K are not to be particularly distinguished from each other.

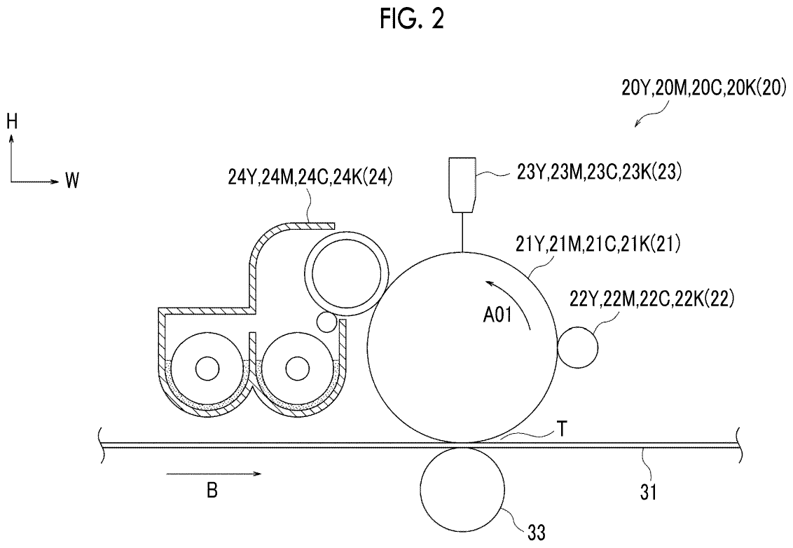

As shown in FIG. 2, the toner image forming unit 20 includes an image holding body 21 rotating in a direction along an arrow A01 in the drawing and a charger 22 that charges the image holding body 21. Furthermore, the toner image forming unit 20 includes an exposure device 23 that forms an electrostatic latent image by causing the image holding body 21 charged by the charger 22 to be exposed to light and a development device 24 that forms a toner image by developing the electrostatic latent image by using toner.

### Transfer Device 30

The transfer device 30 has a function of primarily transferring, to an intermediate transfer body, toner images on the image holding bodies 21 for the respective colors such that the toner images are superimposed on each other and secondarily transferring, to the sheet member P, the superimposed toner images. Specifically, as shown in FIG. 1, the transfer device 30 includes the transfer belt 31 which is the intermediate transfer body, a plurality of rolls 32, primary transfer rolls 33, a transfer cylinder 36, and a scraping member 38.

The transfer belt 31 has an endless shape and is wound around the plurality of rolls 32 such that the transfer belt 31 has an inverted triangular shape. The toner image forming units 20Y, 20M, 20C, and 20K are arranged along the horizontal portion of the transfer belt 31 that is on an upper side. The transfer belt 31 revolves in a direction along an arrow B as at least one of the plurality of rolls 32 is rotationally driven.

In addition, in the following description, the roll 32 that is one of the plurality of rolls 32 and that presses an inclined portion of the transfer belt 31 that is on one side (the left side in the drawing) in the apparatus width direction will be referred to as a roll 32a and the roll 32, around which a portion of the transfer belt 31 that is on the one side in the apparatus width direction is wound, will be referred to as a roll 32b. Furthermore, the roll 32 that is disposed upstream of the roll 32a in a revolution direction of the transfer belt 31 will be referred to as a roll 32c.

The roll 32b functions as a driving roll that is rotationally driven as a drive force from a drive source 34 is applied thereto. In addition, the roll 32c functions as a tensile force applying roll that presses the transfer belt 31 from the inner surface of the transfer belt 31 and that applies a tensile force to the transfer belt 31.

The primary transfer rolls 33 are disposed on a side opposite to the image holding bodies 21 for the respective colors with the transfer belt 31 interposed therebetween. In addition, the primary transfer rolls 33 have a function of transferring, to the transfer belt 31, toner images formed on the image holding bodies 21 at primary transfer positions T between the image holding bodies 21 and the primary transfer rolls 33.

The transfer cylinder 36 is disposed on a side opposite to the roll 32a with the transfer belt 31 interposed therebetween and is rotationally driven. In addition, the transfer cylinder 36 has a function of transferring, to the sheet member P, the toner images transferred onto the transfer belt 31 at a secondary transfer position NT between the transfer belt 31 and the transfer cylinder 36.

The scraping member 38 is disposed between the roll 32a and the roll 32b in the revolution direction of the transfer belt 31 and the scraping member 38 has a function of scraping an adhering substance adhering to a surface of the transfer belt 31 off the transfer belt 31.

### Fixing Device 100

The fixing device 100 has a function of fixing a toner image, which is transferred to the sheet member P by the transfer device 30, onto the sheet member P. As shown in FIG. 1, the fixing device 100 includes a chain gripper 66 and a main heating unit 120 that comes into contact with the sheet member P and that heats a toner image.

### Chain Gripper 66

The chain gripper 66 includes a pair of chains 72, leading end holding portions 68 each of which holds a leading end of the sheet member P, and sprockets 71, 73, 82, 84, and 86.

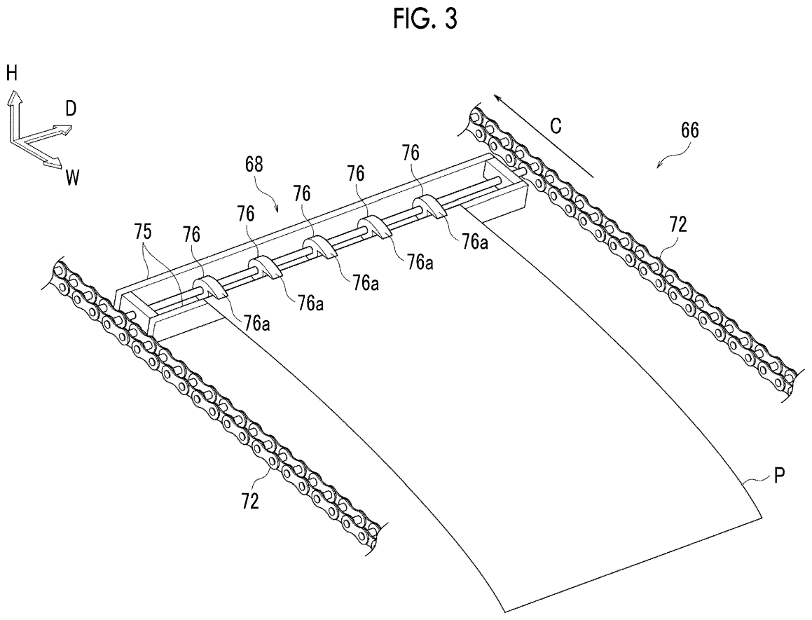

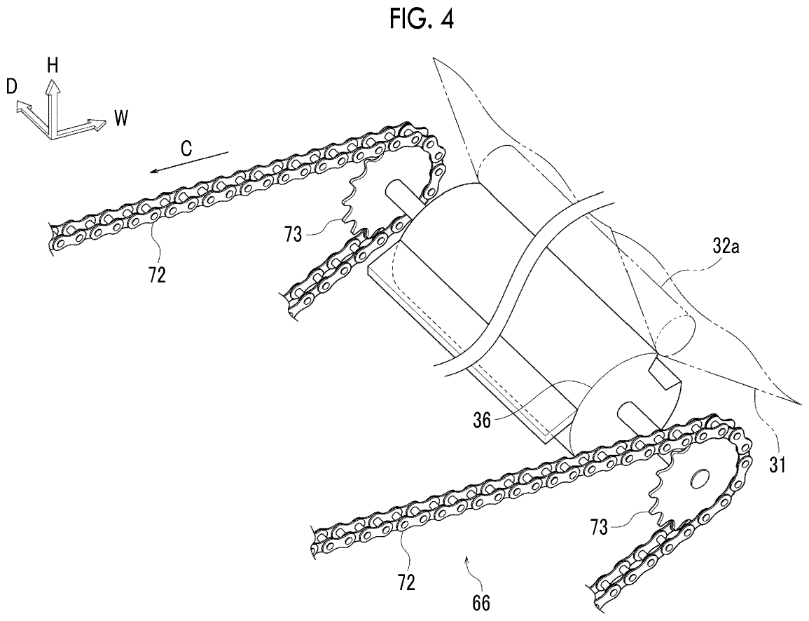

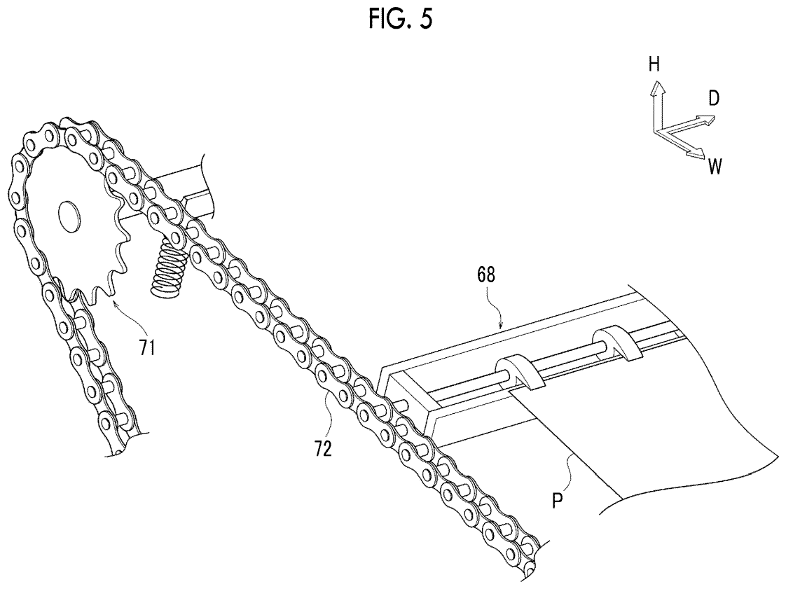

As shown in FIG. 3, the paired chains 72 are disposed to be separated from each other in the apparatus depth direction, and each of the chains 72 is formed in an endless shape. As shown in FIG. 4, the pair of chains 72 is wound around a pair of the sprockets 73 that is disposed on both end sides in an axial direction of the transfer cylinder 36 and of which an axial direction is parallel to the apparatus depth direction. In addition, the pair of chains 72 is wound around a pair of the sprockets 71 (refer to FIG. 5) that is disposed on one end side and the other end side in an axial direction of a pressing cylinder 140 (which will be described later) and of which an axial direction is parallel to the apparatus depth direction. Furthermore, the pair of chains 72 is wound around a pair of the sprockets 82, a pair of the sprockets 84, and a pair of the sprockets 86 that are disposed such that the sprockets are disposed at an interval in the apparatus depth direction.

In addition, as shown in FIG. 1, the sprockets 71 that are disposed on both end sides of the pressing cylinder 140 are disposed closer to the one side (the left side in the drawing) in the apparatus width direction than the sprockets 73 disposed on both end sides of the transfer cylinder 36 are and the sprockets 71 are disposed above the sprockets 73.

In addition, as seen in the apparatus depth direction, the pair of sprockets 82 is disposed below the sprockets 71. Furthermore, the pair of sprockets 86 is disposed below the sprockets 73 and 82, is disposed closer to the one side in the apparatus width direction than the sprockets 73 are, and is disposed closer to the other side in the apparatus width direction than the sprockets 82 are. In addition, the pair of sprockets 84 is disposed to lift, from a lower side to the upper side, portions of the chains 72 that are between the sprockets 82 and the sprockets 86.

As shown in FIG. 3, each leading end holding portion 68 includes an attachment member 75 extending in the apparatus depth direction and grippers 76 attached to the attachment member 75 and both side portions of the leading end holding portion 68 in the apparatus depth direction are attached to the pair of chains 72, respectively.

A plurality of the leading end holding portions 68 are provided and are disposed at predetermined intervals in a circumferential direction (the revolution direction) of the chains 72 (refer to FIG. 1).

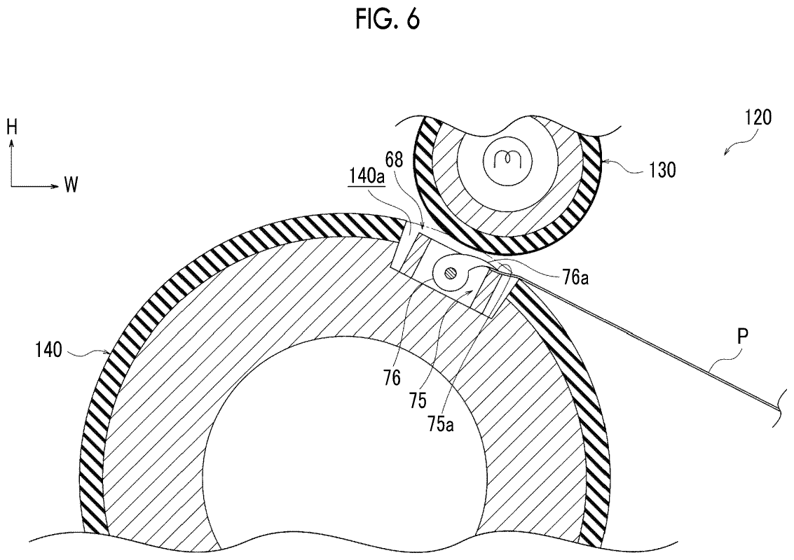

A plurality of the grippers 76 are provided and are attached to the attachment member 75 at predetermined intervals in the apparatus depth direction. Each gripper 76 has a function of holding the leading end of the sheet member P. Specifically, the grippers 76 include claws 76a. In addition, a contact portion 75a (refer to FIG. 6) with which the claws 76a come into contact is formed at the attachment member 75.

The grippers 76 are configured to hold the sheet member P with the leading end of the sheet member P being sandwiched between the claws 76a and the contact portion 75a. Note that, regarding the grippers 76, the claws 76a are pressed against the contact portion 75a by a spring or the like and the claws 76a are opened or closed with respect to the contact portion 75a by the action of a cam or the like.

In this configuration, a rotational force is transmitted to the sprockets 71 and 73 out of the plurality of sprockets 71, 73, 82, 84, and 86 shown in FIG. 1 so that the pair of chains 72 revolve in a direction along an arrow C in the drawing.

Furthermore, when the leading end holding portion 68 attached to the pair of chains 72 reaches the sprockets 73, the grippers 76 of the leading end holding portion 68 hold and receive the sheet member P transported along the supply path 40 by sandwiching the leading end of the sheet member P. Then, the chains 72 revolving in the direction along the arrow C transport, toward the secondary transfer position NT, the sheet member P held by the leading end holding portion 68. Furthermore, the revolving chains 72 transport the sheet member P toward the main heating unit 120. In addition, at a position where the leading end of the sheet member P passes through the main heating unit 120, the leading end holding portion 68 releases the leading end of the sheet member P so that the chain gripper 66 feeds the sheet member P to a discharge path 42. Then, the sheet member P fed to the discharge path 42 is discharged to the outside of an apparatus body 10a.

### Main Heating Unit 120

As shown in FIG. 1, the main heating unit 120 is disposed downstream of the secondary transfer position NT in a transport direction of the sheet member P. In addition, the main heating unit 120 includes a heating roll 130 that comes into contact with the sheet member P transported and that heats the sheet member P and the pressing cylinder 140 that presses the sheet member P toward the heating roll 130. Note that the details of the main heating unit 120 will be described later.

In this configuration, the pressing cylinder 140 presses the sheet member P toward the heating roll 130. Furthermore, the pressing cylinder 140 is rotated by a rotational force transmitted from a drive member (not shown). In addition, the heating roll 130 rotates by being driven by the pressing cylinder 140 rotated. Furthermore, the heating roll 130 and the pressing cylinder 140 transport the sheet member P, onto which a toner image has been transferred, with the sheet member P sandwiched between the heating roll 130 and the pressing cylinder 140, so that the toner image is heated and fixed onto the sheet member P.

### Action of Image Forming Apparatus

In the image forming apparatus 10 shown in FIG. 1, a toner image is formed on the sheet member P as follows. First, the chargers 22 for the respective colors which are shown in FIG. 2 uniformly and negatively charge surfaces of the image holding bodies 21 for the respective colors at a predetermined potential. Next, based on image data input from the outside, the exposure devices 23 irradiate the charged surfaces of the image holding bodies 21 for the respective colors with exposure light to form electrostatic latent images.

Accordingly, electrostatic latent images corresponding to the image data are formed on the respective surfaces of the image holding bodies 21. Furthermore, the development devices 24 for the respective colors develop the electrostatic latent images, and visualize the electrostatic latent images as toner images. In addition, the primary transfer rolls 33 of the transfer device 30 shown in FIG. 1 transfer, to the transfer belt 31, the toner images formed on the surfaces of the image holding bodies 21 for the respective colors at the primary transfer positions T.

Therefore, the sheet member P that is fed from the accommodation unit 50 to the supply path 40 by the feeding roll 58 is delivered to the leading end holding portion 68 (refer to FIG. 3) of the chain gripper 66 and is transported. The sheet member P transported by the chain gripper 66 is fed toward the secondary transfer position NT. At the secondary transfer position NT, the sheet member P is transported while being sandwiched between the transfer belt 31 and the transfer cylinder 36 and thus the toner images on a surface of the transfer belt 31 are transferred onto a surface of the sheet member P.

Furthermore, the fixing device 100 fixes, onto the sheet member P, the toner images transferred onto the surface of the sheet member P and the sheet member P transported by the chain gripper 66 is fed to the discharge path 42. The sheet member P fed to the discharge path 42 is discharged to the outside of the apparatus body 10a.

### Major Configuration

Next, the main heating unit 120 will be described.

As shown in FIG. 6, the main heating unit 120 includes the heating roll 130 that sandwiches the sheet member P transported by the chain gripper 66 (refer to FIG. 1) and that fixes a toner image onto the sheet member P and the pressing cylinder 140 that is disposed to face the heating roll 130. The chains 72 (refer to FIG. 3) constituting the chain gripper 66 are an example of synchronization members. In addition, the chain gripper 66 synchronizes rotation of the pressing cylinder 140 with rotation of the transfer cylinder 36. Here, synchronization means that a rotational motion on one side affects a rotational motion on the other side.

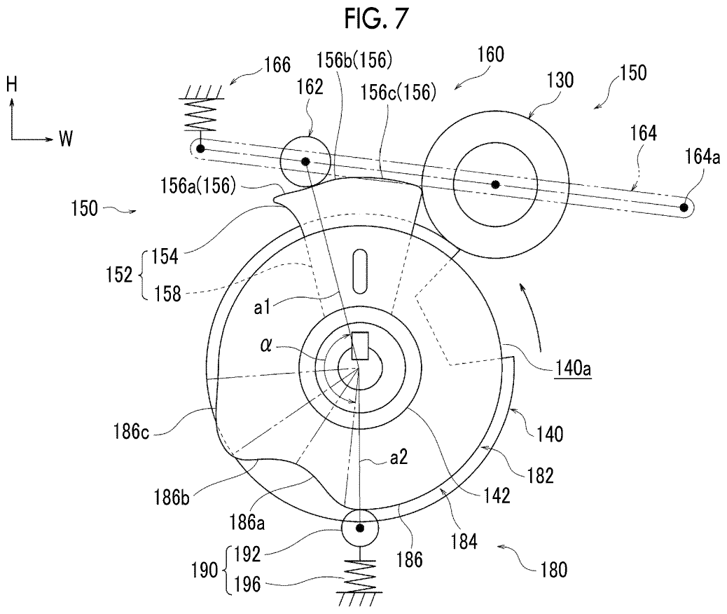

Furthermore, as shown in FIG. 7, the main heating unit 120 includes an approach and separation mechanism 150 that causes the heating roll 130 to approach the pressing cylinder 140 and to be separated from the pressing cylinder 140 and a suppression unit 180 that suppresses load torque acting on the pressing cylinder 140 in a case where the approach and separation mechanism 150 causes the heating roll 130 to approach the pressing cylinder 140 and to be separated from the pressing cylinder 140.

### Heating Roll 130

As shown in FIG. 6, the heating roll 130 is disposed to come into contact with an upward-facing surface of the sheet member P transported and to extend in the apparatus depth direction with an axial direction thereof being parallel to the apparatus depth direction. In addition, both end portions of the heating roll 130 in the apparatus depth direction are provided with supporting members 164 (refer to FIG. 7) that rotatably support the heating roll 130.

### Pressing Cylinder 140

As shown in FIG. 6, the pressing cylinder 140 is disposed to come into contact with, on a side opposite to the heating roll 130 with the sheet member P interposed therebetween, a downward-facing surface of the sheet member P transported and to extend in the apparatus depth direction with an axial direction thereof being parallel to the apparatus depth direction and the pressing cylinder 140 is rotationally driven. In addition, a recess portion 140a extending in the apparatus depth direction is formed at an outer peripheral surface of the pressing cylinder 140. In addition, in a case where the sheet member P passes through a space between the pressing cylinder 140 and the heating roll 130, the recess portion 140a accommodates the leading end holding portion 68 gripping the leading end of the sheet member P.

In addition, in the apparatus depth direction, the pressing cylinder 140 is provided with a rotary shaft 142 and a pressing member (not shown) that presses the sheet member P toward the heating roll 130 via the rotary shaft 142 as shown in FIG. 7.

### Approach and Separation Mechanism 150

As shown in FIG. 7, the approach and separation mechanism 150 includes cam mechanisms 152 that rotate together with the pressing cylinder 140 and a cam follower mechanism 160 that is connected to the heating roll 130.

### Cam Mechanism 152

A pair of the cam mechanisms 152 is provided such that the pressing cylinder 140 is disposed between the cam mechanisms 152 in the apparatus depth direction and the cam mechanisms 152 are attached to the rotary shaft 142 of the pressing cylinder 140. In addition, each cam mechanism 152 includes a cam member 154 having a cam surface 156 formed at an outer periphery thereof and a supporting member 158 that extends in a radial direction of the rotary shaft 142 with the rotary shaft 142 attached to one end of the supporting member 158 and the cam member 154 attached to the other end of the supporting member 158.

### Cam Follower Mechanism 160

The cam follower mechanism 160 includes a cam follower 162 of which a rotation axis direction is parallel to the apparatus depth direction, the supporting members 164 that rotatably support the cam follower 162 and the heating roll 130, and an urging member 166 that urges the cam follower 162 to the cam surfaces 156 of the cam members 154.

The cam follower 162 is disposed on one side (the left side in the drawing) in the apparatus width direction with respect to the heating roll 130, and the supporting members 164 extend through a rotation axis of the cam follower 162 and a rotation axis of the heating roll 130 as seen in the apparatus depth direction.

The supporting members 164 are supported by a frame member (not shown) such that the supporting members 164 can swing around rotary shafts 164a that are formed with the heating roll 130 interposed therebetween at portions of the supporting members 164 on a side opposite to the cam follower 162 and of which an axial direction is parallel to the apparatus depth direction.

In addition, the urging member 166 is a compression coil spring extending in the apparatus up-and-down direction and presses the cam follower 162 against the cam surfaces 156 of the cam members 154. In addition, introduction portions 156a that introduce the cam follower 162 to the cam surfaces 156, lifting portions 156b that lift the cam follower 162 guided to the introduction portions 156a, and maintenance portions 156c that maintain a lifted state of the cam follower 162 lifted by the lifting portions 156b are formed at the cam surfaces 156 of the above-described cam members 154.

In this configuration, the heating roll 130 is in contact with the pressing cylinder 140 in a case where the cam follower 162 is separated from the cam surfaces 156 in a circumferential direction of the pressing cylinder 140. In a case where the pressing cylinder 140 rotates in a counterclockwise direction shown in FIG. 7, the cam follower 162 is guided to the introduction portions 156a of the cam surfaces 156 as shown in FIG. 7.

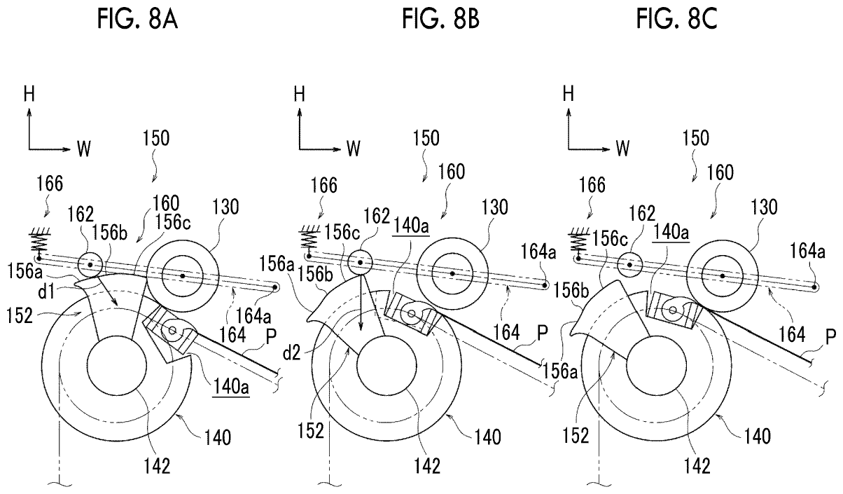

Furthermore, as the cam members 154 rotate together with the pressing cylinder 140, the lifting portions 156b of the cam surfaces 156 reach the cam follower 162 as shown in FIG. 8A. As the lifting portions 156b reach the cam follower 162, the cam follower 162 presses the lifting portions 156b of the cam surfaces 156.

As the cam follower 162 presses the lifting portions 156b of the cam surfaces 156, load torque acts on the pressing cylinder 140. Specifically, load torque in a clockwise direction acts on the pressing cylinder 140 rotating in the counterclockwise direction (refer to an arrow dl in the drawing). Then, as the cam follower 162 passes through the lifting portions 156b, the heating roll 130 is separated from the pressing cylinder 140 before the heating roll 130 reaches the recess portion 140a of the pressing cylinder 140.

Furthermore, as the cam member 154 rotates together with the pressing cylinder 140, the maintenance portions 156c of the cam surfaces 156 reach the cam follower 162 and the cam follower 162 passes through the maintenance portions 156c. In addition, as the cam member 154 rotates together with the pressing cylinder 140, terminal end portions of the maintenance portions 156c of the cam surfaces 156 reach the cam follower 162 as shown in FIG. 8B.

As the cam follower 162 passes through the maintenance portions 156c, the recess portion 140a of the pressing cylinder 140 passes through the heating roll 130 in a state of being separated from the pressing cylinder 140. Then, as the cam follower 162 reaches the terminal end portions of the maintenance portions 156c of the cam surfaces 156, load torque acts on the pressing cylinder 140. Specifically, load torque in the counterclockwise direction further acts on the pressing cylinder 140 rotating in the counterclockwise direction (refer to an arrow d2 in the drawing).

Then, as the cam follower 162 passes through the maintenance portions 156c, the heating roll 130 comes into contact with the pressing cylinder 140 and the sheet member P is sandwiched between the heating roll 130 and the pressing cylinder 140 as shown in FIG. 8C.

### Suppression Unit 180

As shown in FIG. 7, the suppression unit 180 includes cam mechanisms 182 that rotate together with the pressing cylinder 140 and a cam follower mechanism 190.

### Cam Mechanism 182

A pair of the cam mechanisms 182 is provided such that the pressing cylinder 140 is disposed between the cam mechanisms 182 in the apparatus depth direction and the cam mechanisms 182 are attached to the rotary shaft 142 of the pressing cylinder 140. In addition, each cam mechanism 182 includes a cam member 184 having a cam surface 186 formed at an outer periphery thereof. The cam member 184 is an example of another cam member.

A portion of the cam surface 186 that is on a side opposite to the recess portion 140a of the pressing cylinder 140 with the rotary shaft 142 interposed therebetween as seen in the apparatus depth direction has an uneven shape in a radial direction of the pressing cylinder 140. A portion of the cam surface 186 other than the uneven portion has an arc-like shape centered on the rotary shaft 142 as seen in the apparatus depth direction.

### Cam Follower Mechanism 190

The cam follower mechanism 190 includes a cam follower 192 of which a rotation axis direction is parallel to the apparatus depth direction and an urging member 196 that urges the cam follower 192 to the cam surfaces 186 of the cam members 184. The cam follower 192 is an example of another cam follower.

The cam follower 192 is disposed on a side opposite to the cam follower 162 with the rotary shaft 142 of the pressing cylinder 140 interposed therebetween. Here, being disposed on the side opposite to the cam follower 162 with the rotary shaft 142 interposed therebetween means being disposed such that a central angle α formed by a line segment al connecting the center of the rotary shaft 142 and the center of the cam follower 162 and a line segment a2 connecting the center of the rotary shaft 142 and the center of the cam follower 192 is equal to or greater than 150 degrees and equal to or less than 210 degrees.

In addition, the urging member 196 is a compression coil spring extending in the apparatus up-and-down direction and presses the cam follower 192 against the cam surfaces 186 of the cam members 184. In addition, first canceling-out portions 186a that apply load torque in the counterclockwise direction to the pressing cylinder 140 to cancel out load torque in the clockwise direction applied to the pressing cylinder 140 are formed at the cam surfaces 186 of the above-described cam members 184. Furthermore, second canceling-out portions 186b that apply load torque in the clockwise direction to the pressing cylinder 140 to cancel out load torque in the counterclockwise direction applied to the pressing cylinder 140 are formed at the cam surfaces 186 to be adjacent to the first canceling-out portions 186a. In addition, third canceling-out portions 186c that apply load torque in the counterclockwise direction to the pressing cylinder 140 to cancel out load torque in the clockwise direction applied to the pressing cylinder 140 are formed at the cam surfaces 186 to be adjacent to the second canceling-out portions 186b.

In this configuration, as the cam members 154 rotate together with the pressing cylinder 140, the lifting portions 156b of the cam surfaces 156 reach the cam follower 162 as shown in

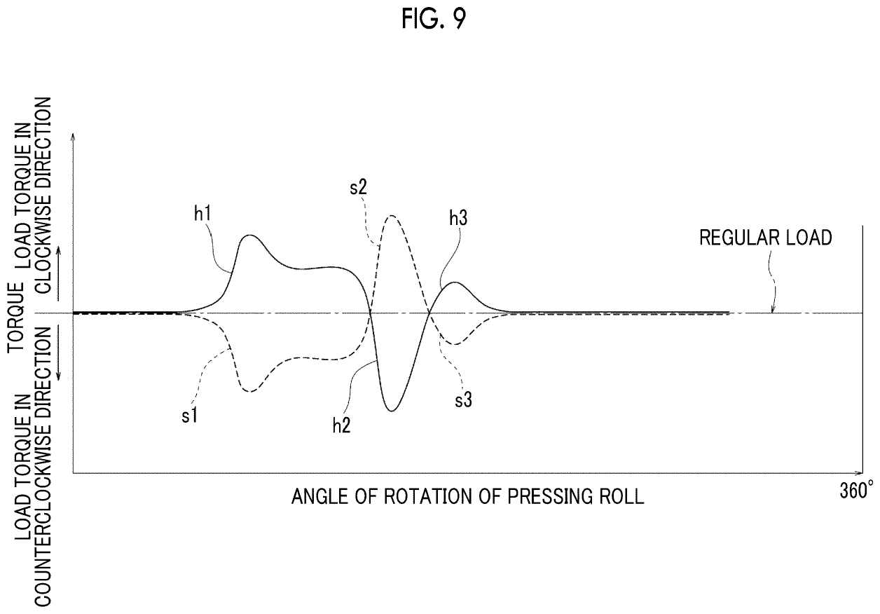

FIG. 8A. Then, as the cam follower 162 presses the lifting portions 156b of the cam surfaces 156, load torque in the clockwise direction acts on the pressing cylinder 140 rotating in the counterclockwise direction (h1 in FIG. 9). Note that in FIG. 9, a graph is shown in which the horizontal axis represents the angle of rotation of the pressing cylinder 140 and the vertical axis represents torque applied to the pressing cylinder 140.

Here, as the cam members 184 rotate together with the pressing cylinder 140, the first canceling-out portions 186a of the cam surfaces 186 reach the cam follower 192. Then, as the cam follower 192 presses the first canceling-out portions 186a, canceling-out torque in the clockwise direction acts on the pressing cylinder 140 (s1 in FIG. 9). Accordingly, the load torque applied to the pressing cylinder 140 is canceled out by the canceling-out torque.

Furthermore, as the cam members 154 rotate together with the pressing cylinder 140, the terminal end portions of the maintenance portions 156c of the cam surfaces 156 reach the cam follower 162 as shown in FIG. 8B. Then, as the cam follower 162 presses the terminal end portions of the maintenance portions 156c, load torque in the counterclockwise direction acts on the pressing cylinder 140 rotating in the counterclockwise direction (h2 in FIG. 9).

Here, as the cam members 184 rotate together with the pressing cylinder 140, the second canceling-out portions 186b of the cam surfaces 186 reach the cam follower 192. Then, as the cam follower 192 presses the second canceling-out portions 186b, canceling-out torque in the clockwise direction acts on the pressing cylinder 140 (s2 in FIG. 9). Accordingly, the load torque applied to the pressing cylinder 140 is canceled out by the canceling-out torque.

Furthermore, as the cam members 154 rotate together with the pressing cylinder 140, the heating roll 130 comes into contact with the pressing cylinder 140 and an elastic layer of the heating roll 130 is elastically deformed as shown in FIG. 8C and thus load torque in the clockwise direction acts on the pressing cylinder 140 rotating in the counterclockwise direction (h3 in FIG. 9).

Here, as the cam members 184 rotate together with the pressing cylinder 140, the third canceling-out portions 186c of the cam surfaces 186 reach the cam follower 192. Then, as the cam follower 192 presses the third canceling-out portions 186c, canceling-out torque in the clockwise direction acts on the pressing cylinder 140 (s3 in FIG. 9). Accordingly, the load torque applied to the pressing cylinder 140 is canceled out by the canceling-out torque.

### Summary

As described above, in the image forming apparatus 10, load torque that is applied to the pressing cylinder 140 by the approach and separation mechanism 150 is canceled out by canceling-out torque that is applied to the pressing cylinder 140 by the suppression unit 180. Accordingly, a fluctuation in rotation speed occurring at the transfer cylinder 36 is suppressed in comparison with a case where a fluctuation in load torque occurring at a pressing cylinder becomes a fluctuation in rotation speed of a pressing cylinder as it is in a configuration in which rotation of the pressing cylinder 140 and rotation of the transfer cylinder 36 are synchronized with each other.

In addition, in the image forming apparatus 10, the suppression unit 180 includes the cam members 184 that are attached to the rotary shaft 142 of the pressing cylinder 140 and that rotate together with the pressing cylinder 140 and the cam follower 192 that is pressed against the cam surfaces 186 of the cam members 184. Accordingly, load torque is reduced with a simple configuration in comparison with a case where canceling-out torque is electrically applied to a rotary shaft of a pressing cylinder so that load torque acting on the pressing cylinder is reduced.

In addition, in the image forming apparatus 10, the cam follower 192 is disposed on a side opposite to the cam follower 162 with the rotary shaft 142 of the pressing cylinder 140 interposed therebetween as seen in the apparatus depth direction. Accordingly, the rotary shaft 142 is restrained from being bent in comparison with a case where the cam follower 192 and the cam follower 162 are disposed on the same side with respect to the rotary shaft 142.

### Second Exemplary Embodiment

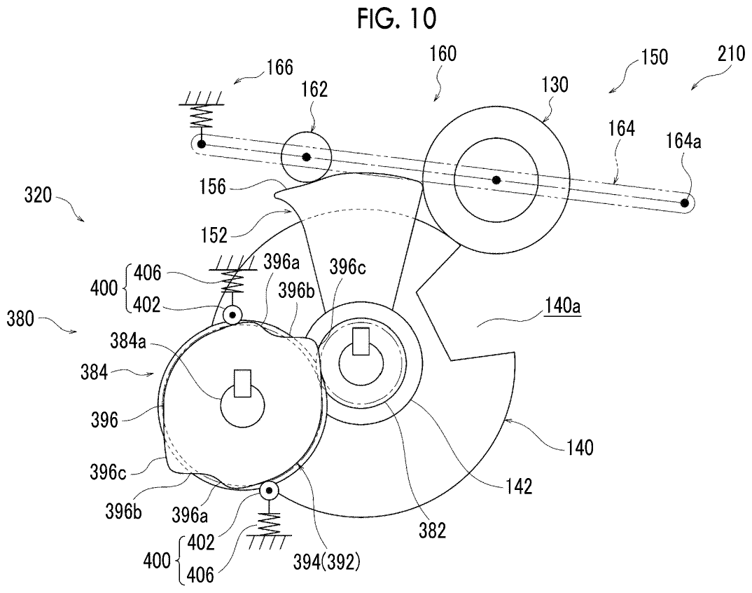

An example of an image forming apparatus according to a second exemplary embodiment of the present disclosure will be described with reference to FIG. 10. The description about the second exemplary embodiment will be made focusing on differences between the second exemplary embodiment and the first exemplary embodiment.

### Major Configuration

As shown in FIG. 10, a main heating unit 320 of an image forming apparatus 210 according to the second exemplary embodiment the heating roll 130 that sandwiches the sheet member P transported and that fixes a toner image onto the sheet member P and the pressing cylinder 140.

Furthermore, the main heating unit 320 includes the approach and separation mechanism 150 that causes the heating roll 130 to approach the pressing cylinder 140 and to be separated from the pressing cylinder 140 and a suppression unit 380 that suppresses a fluctuation in load torque acting on the pressing cylinder 140, which occurs in a case where the approach and separation mechanism 150 causes the heating roll 130 to approach the pressing cylinder 140 and to be separated from the pressing cylinder 140.

### Suppression Unit 380

As shown in FIG. 10, the suppression unit 380 includes first gears 382 that rotate together with the pressing cylinder 140 and second gears 384 that mesh with the first gears 382. Furthermore, the suppression unit 380 includes cam mechanisms 392 that are attached to rotary shafts 384a of the second gears 384 and that rotate together with the rotary shafts 384a of the second gears 384 and cam follower mechanisms 400 that are pressed against cam surfaces 396 of cam members 394 of the cam mechanisms 392.

### First Gear 382, Second Gear 384

A pair of the first gears 382 is provided such that the pressing cylinder 140 is disposed between the first gears 382 in the apparatus depth direction and a pair of the second gears 384 is provided such that the pressing cylinder 140 is disposed between the second gears 384 in the apparatus depth direction.

The first gears 382 are attached to the rotary shaft 142 of the pressing cylinder 140 and rotate together with the pressing cylinder 140. In addition, the diameter of the first gears 382 is smaller than the diameter of the rotary shaft 142. The second gears 384 are disposed on one side in the apparatus width direction with respect to the first gears 382 and mesh with the first gears 382. In addition, the reduction ratio between the second gears 384 and the first gears 382 meshing with each other is two. Two is an example of an integral equal to or greater than two.

### Cam Mechanism 392

A pair of the cam mechanisms 392 is provided such that the pressing cylinder 140 is disposed between the cam mechanisms 392 in the apparatus depth direction. In addition, each cam mechanism 392 includes the cam member 394 having the cam surface 396 formed at an outer periphery thereof. The cam member 394 is an example of another cam member.

Portions of the cam surface 396 that are on both sides with the rotary shaft 384a interposed therebetween as seen in the apparatus depth direction have uneven shapes. A portion of the cam surface 396 other than the uneven portions has an arc-like shape centered on the rotary shaft 384a as seen in the apparatus depth direction.

### Cam Follower Mechanism 400

A pair of the cam follower mechanisms 400 is provided such that the pressing cylinder 140 is disposed between the cam follower mechanisms 400 in the apparatus depth direction. In addition, the cam follower mechanisms 400 include cam followers 402 of which a rotation axis direction is parallel to the apparatus depth direction and urging members 406 that urge the cam followers 402 to the cam surfaces 396 of the cam members 394. The cam followers 402 are an example of other cam followers.

In addition, the urging members 406 are compression coil springs extending in the apparatus up-and-down direction and press the cam followers 402 against the cam surfaces 396 of the cam members 394. In addition, first canceling-out portions 396a that apply load torque in the counterclockwise direction to the pressing cylinder 140 to cancel out load torque in the clockwise direction applied to the pressing cylinder 140 are formed at the cam surfaces 396 of the above-described cam members 394. Furthermore, second canceling-out portions 396b that apply load torque in the clockwise direction to the pressing cylinder 140 to cancel out load torque in the counterclockwise direction applied to the pressing cylinder 140 are formed at the cam surfaces 396 to be adjacent to the first canceling-out portions 396a. In addition, third canceling-out portions 396c that apply load torque in the counterclockwise direction to the pressing cylinder 140 to cancel out load torque in the clockwise direction applied to the pressing cylinder 140 are formed at the cam surfaces 396 to be adjacent to the second canceling-out portions 396b.

### Summary

As described above, in the image forming apparatus 210, as shown in FIG. 10, the suppression unit 380 includes the first gears 382 that rotate together with the pressing cylinder 140 and the second gears 384 that mesh with the first gears 382 with the reduction ratio between the second gears 384 and the first gears 382 being two. Accordingly, a pressing force (an urging force) applied to the cam followers 402 is weakened in comparison with a case where a cam member is attached to a rotary shaft of a pressing roll.

In addition, in the image forming apparatus 210, the suppression unit 380 includes two cam followers 402. Accordingly, a pressing force (an urging force) applied to the cam followers 402 is weakened in comparison with a case where the number of cam followers is one.

Although the specific exemplary embodiments of the present disclosure have been described in detail, the present disclosure is not limited to such exemplary embodiments, and it is apparent to those skilled in the art that various other exemplary embodiments can be adopted within the scope of the present disclosure. For example, in the above-described exemplary embodiments, the suppression units 180 and 380 include the cam members 184 and 394 and the cam followers 192 and 402. However, reduction in load torque may be achieved by electrically applying torque to a rotary shaft of a pressing cylinder. However, in this case, an effect achieved in a case where a cam member and a cam follower are provided cannot be achieved.

In addition, in the above-described first exemplary embodiment, the cam follower 192 is disposed on the side opposite to the cam follower 162 with the rotary shaft 142 of a pressing roll interposed therebetween as seen in the rotation axis direction of the pressing cylinder 140. However, the cam follower 192 and the cam follower 162 may be disposed on the same side with respect to the rotary shaft 142 of the pressing roll. However, in this case, an effect achieved in a case where the cam follower 192 is disposed on a side opposite to the cam follower 162 cannot be achieved.

In addition, in the second exemplary embodiment, the reduction ratio between the second gears 384 and the first gears 382 is two. However, the reduction ratio may be three, four, or the like as long as the reduction ratio is an integer equal to or greater than two.

In addition, in the second exemplary embodiment, the number of the cam followers 402 provided is two, which is equal to the reduction ratio between the second gears 384 and the first gears 382. However, the number of the cam followers 402 may be one. However, in this case, an effect achieved in a case where the number of the cam followers 402 provided is two, which is equal to the reduction ratio between the second gears 384 and the first gears 382, cannot be achieved.

In addition, in the second exemplary embodiment, the two cam followers 402 are provided since the reduction ratio between the second gears 384 and the first gears 382 is two. However, in a case where the reduction ratio between the second gears and the first gears is N, N cam followers 402 may be provided. In addition, although the number of the cam followers 402 may be a number other than N, an effect achieved in a case where N cam followers 402 are provided cannot be achieved in this case.

(((1)))

An image forming apparatus comprising:
a transfer cylinder that sandwiches a transported recording medium while rotating and that transfers an image onto the recording medium, the recording medium being sandwiched between the transfer cylinder and a transfer member onto which the image is transferred;
a heating roll that is disposed downstream of the transfer cylinder in a transport direction of the recording medium and that heats the transported recording medium while rotating;
a pressing cylinder that is disposed to face the heating roll, that rotates in synchronization with rotation of the transfer cylinder, and that presses the transported recording medium toward the heating roll;
an approach and separation mechanism that includes a cam member that rotates together with the pressing cylinder and a cam follower that is connected to the heating roll and that is pressed against a cam surface of the cam member, the approach and separation mechanism causing the heating roll to approach the pressing cylinder and to be separated from the pressing cylinder; and
a suppression unit that suppresses load torque that acts on the pressing cylinder since the approach and separation mechanism causes the heating roll to approach the pressing cylinder and to be separated from the pressing cylinder.
   (((2)))

The image forming apparatus according to (((1))),
wherein the suppression unit includes another cam member that is attached to the pressing cylinder and that rotates together with the pressing cylinder and another cam follower that is pressed against another cam surface of the other cam member.
   (((3)))

The image forming apparatus according to (((2))),
wherein the other cam follower is disposed on a side opposite to the cam follower with a rotary shaft of the pressing cylinder interposed therebetween as seen in a rotation axis direction of the pressing cylinder.
   (((4)))

The image forming apparatus according to (((1))),
wherein the suppression unit includes a first gear that is attached to the pressing cylinder and that rotates together with the pressing cylinder, a second gear that meshes with the first gear such that a reduction ratio between the first gear and the second gear is an integer equal to or greater than two, another cam member that is attached to the second gear and that rotates together with the second gear, and another cam follower that is pressed against another cam surface of the other cam member.
   (((5)))

The image forming apparatus according to (((4))),
wherein the number of other cam followers is N in a case where the reduction ratio is N.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a transfer cylinder that sandwiches a transported recording medium while rotating and that transfers an image onto the recording medium, the recording medium being sandwiched between the transfer cylinder and a transfer member onto which the image is transferred;
a heating roll that is disposed downstream of the transfer cylinder in a transport direction of the recording medium and that heats the transported recording medium while rotating;
a pressing cylinder that is disposed to face the heating roll, that rotates in synchronization with rotation of the transfer cylinder, and that presses the transported recording medium toward the heating roll;
an approach and separation mechanism that includes a cam member that rotates together with the pressing cylinder and a cam follower that is connected to the heating roll and that is pressed against a cam surface of the cam member, the approach and separation mechanism causing the heating roll to approach the pressing cylinder and to be separated from the pressing cylinder; and
a suppression unit that suppresses load torque that acts on the pressing cylinder since the approach and separation mechanism causes the heating roll to approach the pressing cylinder and to be separated from the pressing cylinder.

2. The image forming apparatus according to claim 1,
wherein the suppression unit includes another cam member that is attached to the pressing cylinder and that rotates together with the pressing cylinder and another cam follower that is pressed against another cam surface of the other cam member.

3. The image forming apparatus according to claim 2,
wherein the other cam follower is disposed on a side opposite to the cam follower with a rotary shaft of the pressing cylinder interposed therebetween as seen in a rotation axis direction of the pressing cylinder.

4. The image forming apparatus according to claim 1,
wherein the suppression unit includes a first gear that is attached to the pressing cylinder and that rotates together with the pressing cylinder, a second gear that meshes with the first gear such that a reduction ratio between the first gear and the second gear is an integer equal to or greater than two, another cam member that is attached to the second gear and that rotates together with the second gear, and another cam follower that is pressed against another cam surface of the other cam member.

5. The image forming apparatus according to claim 4,
wherein the number of other cam followers is N in a case where the reduction ratio is N.
